(19) United States
(12) Patent Application Publication
(10) Pub. No.: US 2008/0310187 A1
(43) Pub. Date: Dec. 18, 2008

(54) LIGHT GUIDE DEVICE FOR VEHICLE LAMPS

(75) Inventor: Jack HUANG, Tucheng City (TW)

Correspondence Address: PATENTTM.US, P. O. BOX 82788, PORTLAND, OR, 97282-0788, US

(73) Assignee: YUJING TECHNOLOGY CO., LTD., Tucheng City (TW)

(21) Appl. No.: 12/194,486

(22) Filed: Aug. 19, 2008

Related U.S. Application Data
(63) Continuation-in-part of application No. 11/427,258, filed on Jun. 28, 2006.

(51) Int. Cl. F21V 8/00

(52) U.S. Cl. 362/615

(57) ABSTRACT

A light guide device has a body and multiple grooves. The body has a radiation surface and a flat surface formed oppositely to the radiation surface. The grooves are formed inward from the flat surface into the body, and each groove is cambered, is separated from adjacent grooves with intervals and has a curvature. The grooves in a center segment of the body have the same curvature larger than the curvatures of other grooves. When light beams emit to the grooves, the light beams are refracted toward and outward the radiation surface by the grooves. Larger curvature of the groove results in smaller scatter angle of the light beams refracted by the groove. The refracted light beams having smaller scatter angle result in higher illumination.

### CROSS REFERENCE

The present invention is a continuation-in-part of application Ser. No. 11/427,258 filed on Jun. 28, 2006.

### BACKGROUND OF THE INVENTION

1. Field of the Invention

The present invention relates to a light guide device for vehicle lamps, and more particularly to a light guide device that has multiple grooves, and each groove is separated from adjacent grooves with different intervals and has a specific curvature.

2. Description of Related Art

To increase traffic safety, vehicles are regulated to install many different kinds of lamps such as warning lamps or indication lamps. The lamps installed on a vehicle comprise head lamps, turn signal lamps, tail lamps, stop lamps and etc. Illuminating shapes of the lamps and emitting more uniform light beams by the lamps on the vehicles are critical.

With reference to U.S. Pat. No. 6,910,783 and FIG. 6 (as shown in FIG. 1 in U.S. Pat. No. 6,910,783), a conventional lamp for installing on a vehicle comprises a light guide device (30) and a light source (40). The light guide device (30) is transparent and has a front surface (31), a rear surface (32) and multiple grooves (321). The grooves (321) are formed on the rear surface (32) of the light guide device (30), and each groove (321) has a bottom caved in the light guide device (30) and is separated from the adjacent groove (321) by an interval. The light source (40) are partially mounted in the light guide device (30) and connects to a power source. When the light source (40) is activated to emit light beams to the light guide device (30), the light beams will transmit in the light guide device (30) by total reflection. When the reflected light beams emit to the outer bottoms of the grooves (321), the outer bottoms of the grooves (321) refract the light beams toward and outward the front surface (31) of the light guide device (30). Therefore, with changing the interval between adjacent grooves (321), the distribution of the refracted light beams changes. The grooves (321) with shorter intervals will provide more concentrated refracting light beams than that with larger intervals. Therefore, if the intervals between the grooves (321) away from the light source (40) are shorter than the intervals between the grooves (321) near the light source (40), the illumination from the light guide device (30) will be in a uniform distribution.

However, the distribution of the light beams emitted from the motor vehicle signal lamps are regulated by the Society of Automotive Engineers (SAE) specifications. For example, tail lamps are regulated by SAE J585, stop lamps are regulated by SAE J586, and turn signal lamps are regulated by SAE J588. The SAE specifications regulate that each lamp radiates the highest illumination at the center of the lamp. The above-mentioned vehicle lamp cannot exactly match the SAE specifications.

To overcome the shortcomings, the present invention provides a light guide device for vehicle lamps to mitigate or obviate the aforementioned problems.

### SUMMARY OF THE INVENTION

The main objective of the invention is to provide a light guide device for vehicle lamps that has multiple protrusions, and each protrusion is separated from adjacent protrusions with different intervals and has a specific curvature.

The light guide device in accordance with the present invention comprises a body and multiple grooves. The body has a radiation surface and a flat surface formed oppositely to the radiation surface. The grooves are formed inward from the flat surface into the body, and each groove is cambered, is separated from adjacent grooves with intervals and has a curvature. The grooves in a center segment of the body have the same curvature larger than the curvatures of other grooves. When light beams emit to the grooves, the light beams are refracted toward and outward the radiation surface by the grooves. Larger curvature of the groove results in smaller scatter angle of the light beams refracted by the groove. The refracted light beams having smaller scatter angle result in higher illumination to conform the Society of Automotive Engineers (SAE) specifications.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a light guide device in accordance with the present invention;

FIG. 2 is a side view of a first embodiment of the light guide device in accordance with the present invention;

FIG. 3 is a partial side view of FIG. 2 and shows trajectories of light beams;

FIG. 4 is a perspective view of a second embodiment of the light guide device in accordance with the present invention;

FIG. 5 is a side view of FIG. 4; and

FIG. 6 is a side view of a conventional light guide device.

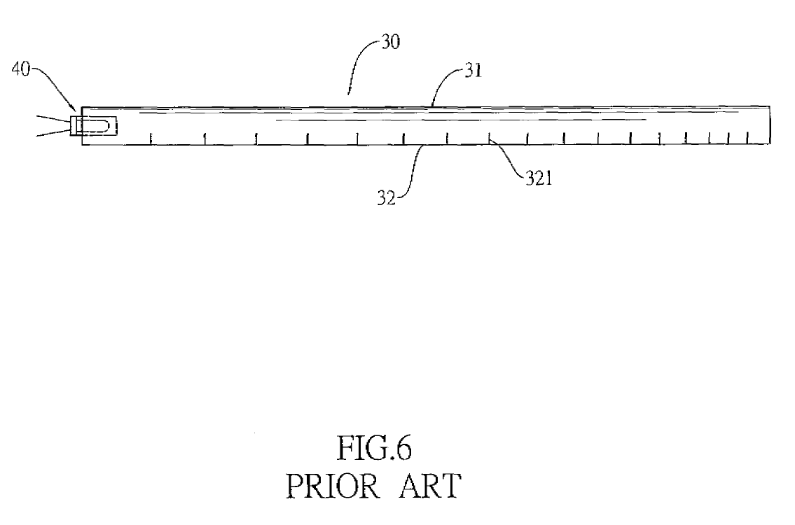

### DETAILED DESCRIPTION OF PREFERRED EMBODIMENT

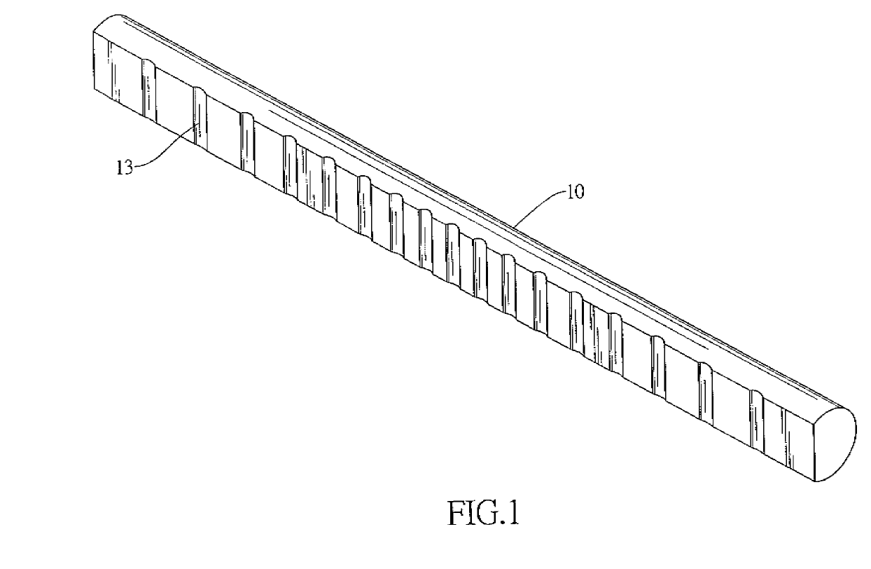

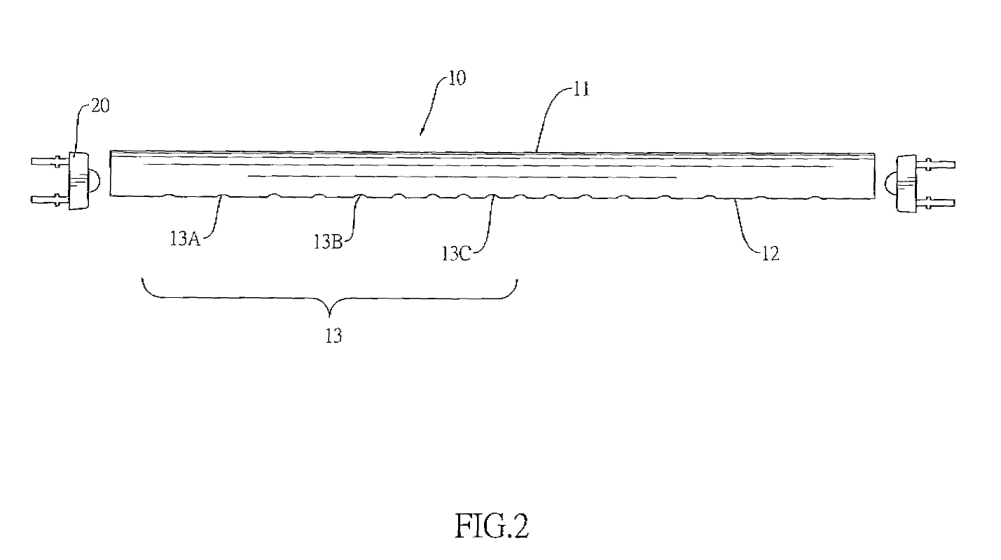

With reference to FIGS. 1 and 2, a vehicle lamp comprises a light guide device in accordance with the present invention and at least one light source (20).

The light guide device comprises a body (10) and multiple grooves (13).

The body (10) is transparent, straight and elongated and has an axis, a center segment, a curved radiation surface (11), a flat surface (12) and two ends. The flat surface (12) is formed oppositely to the radiation surface (11).

The grooves (13) are formed inward from the flat surface (12) into the body (10). Each groove (13) is cambered, is separated from adjacent grooves (13) with intervals and has a curvature. Each interval between adjacent two grooves (13) may be different from other intervals. The curvature of each groove (13) may be different from the curvatures of other grooves (13).

The light source (20) is mounted on one of the two ends of the body (10) and emits light beams toward the body (10). The light beams in the body (10) are transmitted by total reflection and are refracted outward from the radiation surface (11) by the grooves (13). Different curvatures of the grooves (13) or different intervals between the grooves (13) result in different distributions of the refracted light beams.

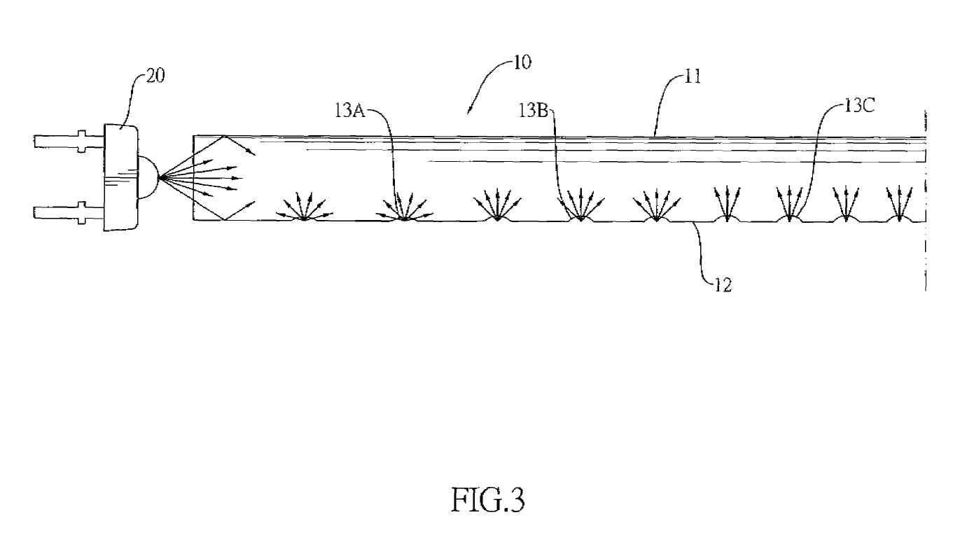

With further reference to FIGS. 2 and 3, in a first embodiment of the present invention, the grooves (13) are formed vertical to the axis of the body (10). Furthermore, the grooves (13) are divided into a first set of grooves (13A), a second set of grooves (13B) and a third set of grooves (13C), and the third set of grooves (13C) are in the center segment of the body (10). Each groove (13) in the first set of grooves (13A) is separated from adjacent grooves (13) by a first interval and has a first curvature. Each groove (13) in the second set of grooves (13B) is separated from adjacent grooves (13) by a second interval and has a second curvature. Each groove (13) in the third set of grooves (13C) is separated from adjacent grooves (13) by a third interval and has a third curvature. The third interval is shorter than the second interval, and the second interval is shorter than the first interval.

The third curvature is larger than the second curvature, and the second curvature is larger than the first curvature. Larger curvature of the groove (13) results in smaller scatter angle of the light beams refracted by the groove (13C) having larger curvature. Additionally, shorter interval between adjacent grooves (13) results in that the light beams refracted by the grooves (13) separated with shorter intervals are more centralized.

The light beams that are centralized and have smaller scatter angles result in higher illumination. Therefore, the illumination of the light beams refracted by the third set of grooves (13C) is higher than the illumination of the light beams refracted by the other sets of grooves (13A, 13B), and the illumination of the light beams refracted by the second set of grooves (13B) is higher than the illumination of the light beams refracted by the first set of grooves (13A).

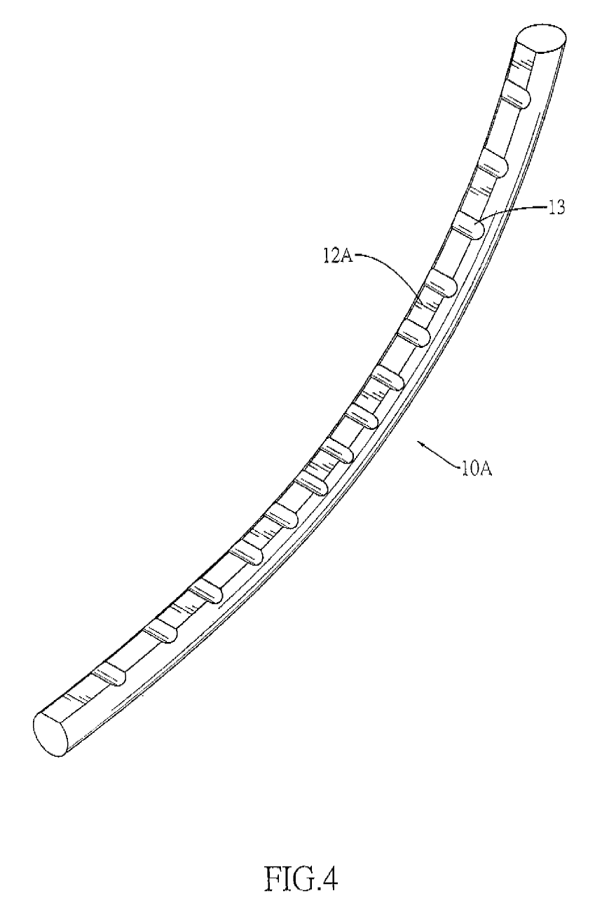

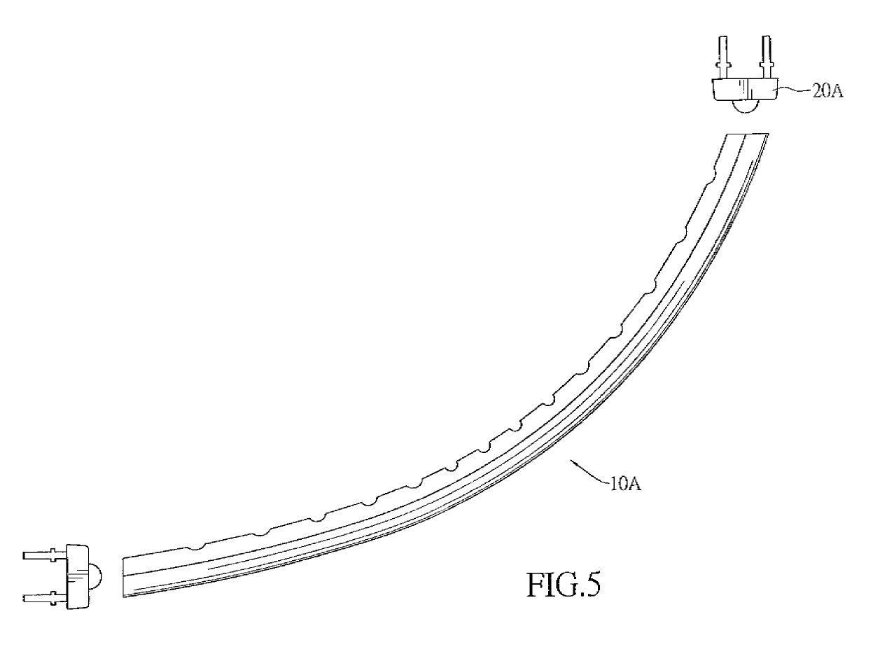

With further reference to FIGS. 4 and 5, in a second embodiment of the present invention, the body (10A) is not straight but cambered. The grooves (13) can be designed as disclosed in the first embodiment of the present invention.

With reference to FIGS. 2 to 5 again, there are two light sources (20) mounted respectively on the two ends of the body (10, 10A) and emitting light beams toward the body (10, 10A).

With such a light guide device, the illumination of the light beams at the center segment of the body (10, 10A) is higher because each groove (13) in the third set of grooves (13C) has larger curvature. Consequently, the light guide device of the present invention helps to radiate the highest illumination at the center segment of the body (10, 10A) to conform to the Society of Automotive Engineers (SAE) specifications. The light guide device of the present invention is better than the conventional light guide device due to the conventional light guide device is designed to provide uniform illumination distribution.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A light guide device for vehicle lamps comprising: a body being transparent and elongated and having
a center segment;
an axis;
a radiation surface;
a flat surface being formed oppositely to the radiation surface; and
two ends; and
multiple grooves being formed inward from the flat surface into the body to refract light beams emitting outward from the radiation surface, and each groove being cambered, being separated from adjacent grooves with intervals and having a curvature;
wherein the grooves in the center segment of the body have the same curvature that are larger than the curvatures of other grooves to provide higher illumination at the center segment of the body when the light beams are refracted by the grooves.

2. The light guide device as claimed in claim 1, wherein the intervals between the grooves that are in the center segment of the body are shorter than the intervals between other grooves.

3. The light guide device as claimed in claim 1, wherein the body is straight.

4. The light guide device as claimed in claim 2, wherein the body is straight.

5. The light guide device as claimed in claim 1, wherein the body is cambered.

6. The light guide device as claimed in claim 2, wherein the body is cambered.

7. The light guide device as claimed in claim 1, wherein the grooves are formed vertical to the axis of the body.

8. The light guide device as claimed in claim 2, wherein the grooves are formed vertical to the axis of the body.

9. The light guide device as claimed in claim 3, wherein the grooves are formed vertical to the axis of the body.

10. The light guide device as claimed in claim 4, wherein the grooves are formed vertical to the axis of the body.

11. The light guide device as claimed in claim 5, wherein the grooves are formed vertical to the axis of the body.

12. The light guide device as claimed in claim 6, wherein the grooves are formed vertical to the axis of the body.
